(19) United States
(12) Patent Application Publication
(10) Pub. No.: US 2025/0392256 A1
(43) Pub. Date: Dec. 25, 2025

(54) SOLAR CELL PRODUCTION PROCESS AND SOLAR CELL PRODUCTION SYSTEM

(71) Applicant: WAVELABS SOLAR METROLOGY SYSTEMS GMBH, Leipzig (DE)

(72) Inventors: Bernhard MITCHELL, Leipzig (DE); Maximilian SCHERFF, Leipzig (DE); Bernhard KLÖTER, Leipzig (DE)

(73) Assignee: WAVELABS SOLAR METROLOGY SYSTEMS GMBH, Leipzig (DE)

(21) Appl. No.: 18/879,588

(22) PCT Filed: Jun. 26, 2023
(86) PCT No.: PCT/EP2023/067291

§ 371 Date: Dec. 27, 2024

(30) Foreign Application Priority Data
Jun. 28, 2022 (DE) 102022116064.5

(51) Int. Cl. H02S 50/15

(52) U.S. Cl. CPC H02S 50/15

(57) ABSTRACT

A solar cell testing process includes the following method steps: carrying out at least one primary measurement by means of a primary measuring method on substantially each of the multiple solar cells in order to obtain a primary measurement result for each of the multiple solar cells; carrying out a secondary measurement by means of a secondary measuring method on at least one of the produced solar cells in order to obtain a secondary measurement result; and classifying each of the multiple solar cells in a sorting category according to the primary measurement result and/or secondary measurement result associated with the solar cell; wherein the secondary measurement is carried out by means of the secondary measurement method on a subset of the multiple solar cells, and the primary measuring method and/or the primary measurement result is/are calibrated according to the secondary measurement result.

The invention relates to a solar cell test procedure, a solar cell production process, a solar cell test installation and a solar cell production plant.

In modem solar cell production plants, the solar cells are subjected to a series of tests or measurements following their manufacture. These measurements are used firstly for quality assurance, since poor or defective solar cells are sorted out as a result. Secondly, the result of such tests can be used to sort the solar cells produced, in particular on the basis of their power or effectiveness. The sorting is also referred to as binning. A solar cell is measured directly at the end of a production line, that is to say in a so-called end-of-line test. This has the advantage that the solar cells do not first have to be conveyed to another location, and perhaps even packed beforehand, in order to test them there.

At present, 100% of solar cells are contact-connected by means of IV solar simulators at the end of manufacture and measured according to standard and converted to standardized values according to standard test conditions (STC). This is therefore referred to here as 100% STC testing. The measuring systems used for this purpose are complex, expensive and their throughput can barely be accelerated further. STC tests of the IV characteristic curve (according to IEC 60904) comprise standardized illumination of each solar cell with a standard light spectrum (AM 1.5 G). For an AM 1.5 G light condition, irradiation with 1 sun is defined as a radiation density of 100 mW/cm². During this irradiation, the current-voltage characteristic (IV measurement curve or simple IV curve) is measured in order, inter alia, to determine the electrical power of the solar cell under standard illumination. Illumination according to a standard spectrum and an intensity can be realized only by relatively expensive LED or xenon illumination units, since the requirements for intensity, spectrum, stability and homogeneity are high.

EP 2 823 899 A1 discloses a method and a binning apparatus for sorting solar cell wafers in applicable containers on the basis of their characterization. For this purpose, the solar cells are tested and measured by means of different inspection equipment. The tests are used to detect damage to the solar cell wafers, to determine their respective color and to determine their optical and electronic properties.

EP 1 647 827 A1 describes a test system for solar cells that has an optical testing device and an electrical testing device, which are arranged along a conveyor belt system. The solar cells, driven by the conveyor belt system, pass through the testing devices and are tested or measured both optically and electrically.

The object of the invention is to reduce the operating costs per produced solar cell. The invention achieves this in particular by reducing the plant complexity and increasing the throughput of the end-of-line cell testing and sorting.

According to the invention, the object is achieved by a solar cell test procedure having the features of claim 1, by a solar cell production process having the features of claim 8, by a solar cell test installation having the features of claim 9 and by a solar cell production plant having the features of claim 10. Advantageous developments of the invention are listed in the subclaims.

According to one aspect of the invention, a solar cell test procedure is proposed that is fed multiple previously produced solar cells for testing. By way of example, the solar cells can be supplied in groups, e.g. in a packaged form, and subjected to the solar cell test procedure. According to another aspect of the invention, a solar cell production process is proposed in which solar cells are produced and subsequently fed to the solar cell test procedure.

Preferably, the solar cells are produced continuously and also subjected to the testing or measurement regime explained below continuously. By way of example, the solar cells produced can be tested in the order in which they are produced. The group of solar cells produced that is referred to as “multiple solar cells” may also be a solar cell produced within a period of time, for example within one hour, one day or one week.

First, at least one primary measurement is carried out on the solar cells by means of a primary measurement method. This primary measurement is effected on substantially each of the solar cells produced. Here, “substantially” means that no more than a subset of solar cells that is negligible compared to the total quantity of solar cells is not measured by means of the primary measurement method, for example solar cells that are obviously defective, in particular are shattered, or have scratches or color defects. Alternatively, automatic detection of obvious defects such as these can also be considered as the result of a primary measurement or a partial measurement section of the primary measurement method.

The primary measurement is used to determine a primary measurement result for each solar cell. Multiple primary measurements can be carried out on each solar cell in parallel or in succession by means of different primary measurement methods. Accordingly, it is thus possible to determine multiple primary measurement results. It should be pointed out here that the terms primary measurement and secondary measurement, which is defined later, are not used to stipulate a temporal or other order between the measurements. Primary measurement refers to a sum total of first measurements and secondary measurement refers to a sum total of second measurements. The primary measurement differs from the secondary measurement in that substantially all of a considered quantity of solar cells are subjected to the primary measurement and only a subset is subjected both to the primary measurement and to the secondary measurement.

Subsequent to the primary measurement or the primary measurements, or alternatively at a time between a first and a second primary measurement, a secondary measurement is carried out on at least one of the produced solar cells by means of a secondary measurement method in order to obtain a secondary measurement result. Here, too, multiple secondary measurements can be carried out on a solar cell at the same time or in succession by means of different secondary measurement methods. Accordingly, it is thus possible to determine multiple secondary measurement results.

The primary measurement result/the primary measurement results and/or the secondary measurement result/the secondary measurement results can each comprise a metric, a qualification and/or a set of metrics or qualifications. In particular, the primary measurement result and/or the secondary measurement result can comprise a measurement curve, for example a current-voltage measurement curve (IV measurement curve) or a photoluminescence (PL) image, an electroluminescence (EL) image or an infrared (IR) image.

After the measurement(s) have been carried out on a solar cell, the solar cell is sorted into a corresponding sorting category, that is to say the so-called binning is effected. This is accomplished by virtue of the suitable sorting category being selected according to the primary measurement result belonging to the solar cell. In addition or alternatively, the sorting category can also be selected on the basis of the secondary measurement result. In particular, the primary measurement result can be taken as a basis for determining a power value or an effectiveness of the solar cell. The secondary measurement result, that is to say in particular the IV characteristic curve, can preferably also be used to determine a power value or an effectiveness of the solar cell.

The invention is based on the idea of additionally measuring only a subset of the solar cells that have been measured by means of the primary measurement method by means of the secondary measurement method and of calibrating the primary measurement method and/or the primary measurement result based on the primary measurement result and the secondary measurement result. In other words, the secondary measurement by means of the secondary measurement method is carried out on (only) a subset of the multiple solar cells and the primary measurement method and/or the primary measurement result are/is calibrated according to the secondary measurement result. The solar cells that have not been measured by means of the secondary measurement method are sorted on the basis of the primary measurement result determined on them. This approach has the advantage that the solar cells can be measured and sorted faster than if all solar cells were measured using both the primary measurement method and the secondary measurement method.

The primary measurement method may in particular be a faster and/or more cost-effective measurement method than the secondary measurement method. By contrast, the secondary measurement method should be designed in such a way that it can be used to calibrate the primary measurement method. According to the invention, the secondary measurement method is thus regarded as the normal measurement method or standard measurement method, while the primary measurement method is used as a faster and/or less expensive alternative to the secondary measurement method. A calibration is performed in order to match or take the informative value of the primary measurement result to that of the secondary measurement result. Preferably, the calibration is effected regularly. The calibration is rated on the basis of precision, i.e. the variability between primary and secondary measurement, and accuracy, i.e. the mean difference between primary and secondary measurement, an average being calculated over a defined production or measurement period here, e.g. 1, 10 or 100 minutes.

Using the primary measurement method on a solar cell determines a primary measurement result. In this case, a conversion algorithm can be carried out as part of the primary measurement method in order to derive the primary measurement result from raw data acquired in the primary measurement method. This conversion algorithm can be a mathematical formula or a machine learning algorithm. In all cases, the conversion algorithm may be defined by model parameters. As explained below, these model parameters can be adapted as part of a calibration process.

Preferably, the primary measurement method is calibrated according to the secondary measurement result. This can involve model parameters of the primary measurement method being adapted in such a way that characteristic values of the solar cell that have been derived from the primary measurement results substantially correspond to characteristic values of the same solar cell that have been derived from the secondary measurement results. Alternatively or additionally, the primary measurement result can be calibrated according to the secondary measurement result. This involves the primary measurement result itself or the characteristic value of the solar cell that has been derived therefrom being converted in such a way that the primary measurement result substantially corresponds to the secondary measurement result and/or that the characteristic value of the solar cell that has been derived from the secondary measurement result substantially corresponds to the characteristic value of the solar cell that has been derived from the primary measurement result. It thus becomes possible to infer the secondary measurement results with a certain accuracy using the primary measurement results only. For this purpose, it is possible in particular to adapt model parameters in the algorithms that are used to convert from the primary measurement result to the characteristic value.

In an expedient embodiment, there is provision for the secondary measurement method to comprise a contact-connecting measurement method. This means that the measurement involves electrically contact-connecting the solar cell to be measured. The solar cell can then be illuminated or irradiated by means of an illumination apparatus, with electrical variables, in particular current and/or voltage, being measured at the contact-connection(s) during or after the irradiation. The latter measurement can be effected at one time or over a period of time. It is also possible to determine a mean value of an electrical variable over a specific period of time. By way of example, the current or voltage generated in the solar cell on account of the illumination can be measured over the period of time. Alternatively or additionally, the contact-connection can be used to adjust one electrical variable while another electrical variable is simultaneously measured at the contact-connection. This allows a current-voltage characteristic curve (IV characteristic curve) to be determined, for example. This can be done with or without illumination.

The secondary measurement method is preferably a current-voltage solar simulator measurement under standard test conditions (STC). Such STC measurements of the IV characteristic curve (according to the IEC 60904 standard) include standardized illumination of the solar cell with a standard light spectrum (AM1.5G). The current-voltage characteristic is measured to determine the electrical power of the solar cell under standard illumination.

Illumination with a standard spectrum and standard intensity can be realized, for example, by means of LED or xenon illumination units, since the requirements for intensity, spectrum, stability and homogeneity are high.

The primary measurement method is preferably a faster and/or less expensive measurement method than the secondary measurement method. In particular, the primary measurement method dispenses with illumination according to standard test conditions (STC). The hybridization of the cell measurement in such non-STC measurements and STC measurements permits increased throughput, in particular when the non-STC measurements are effected contactlessly, as occurs, for example, in the case of the photoluminescence measurement. The installation engineering for non-STC measurements is significantly more cost-effective.

Preferably, the primary measurement method comprises one or more luminescence measurements in which luminescence images of the solar cell surface are captured, in particular an electroluminescence measurement and/or a photoluminescence measurement. The electroluminescence measurement involves contact-connecting the solar cell and exciting it by means of electrical signals, that is to say in particular by means of a flow of current or an applied voltage. A photoluminescence measurement involves exciting the solar cell by means of irradiation, in particular laser irradiation. In both cases, the luminescence images can be captured by means of a camera. In this case, there is the option of the entire surface of a solar cell being captured at once by the camera. Alternatively, it is possible to scan the solar cell surface in regions by means of the camera.

Luminescence measurements are in equilibrium within the excess charge carrier lifetime, which is approximately 1 millisecond (ms) or is of the order of magnitude of 1 ms. A hysteresis behavior, as is known e.g. from IV characteristic curve measurements of high-power silicon solar cells, does not arise as a result, since the external covering is not changed over time. Thus, even measurements on moving solar cells, that is to say so-called “on-the-fly” measurements, are possible if local exposure times are in the range of a few milliseconds. Such luminescence measurements are therefore at least one order of magnitude faster than measurements of the power that are derived from IV characteristic curves.

Preferably, a power value, a power class and/or an effectiveness of the solar cell are determined from one or more luminescence image(s) captured from a solar cell and are used as a basis for the sorting. In addition, it is also possible to determine the characteristic curve parameters, in particular the short-circuit current Isc, the open-circuit voltage Voc and/or the fill factor. The luminescence image or luminescence images is or are preferably recorded or captured in such a way that they contain relevant information in order to derive therefrom the power value, the power class and/or the effectiveness of the solar cell, for example with resistance effects, or this requires further primary measurements. Preferably, the luminescence image(s) is/are evaluated for this purpose, for example by means of feature recognition using machine learning algorithms, in particular using artificial neural networks.

For the recording of luminescence images, the following variants, inter alia, are possible:
recording multiple luminescence images for respective different injection levels. This variant is able to be used both for photoluminescence measurement (PL) and for electroluminescence measurement (EL).
recording multiple luminescence images for respective different illumination wavelengths. This variant is able to be used in particular for photoluminescence measurement (PL).
recording multiple luminescence images for respective different detection wavelength ranges.
recording multiple luminescence images, in each case with front and/or rear illumination (PL) and detection (PL, EL)

In a preferred embodiment, there is provision for the primary measurement method to comprise a contactless measurement method. In addition to the photoluminescence measurement, this option includes contactless measurement of the external quantum efficiency EQE (“PL-QE”), contactless measurement of the series resistance and the so-called “suns-PL” measurement. A common feature of all of these measurements is that signals are transmitted via the photoluminescence radiation and only the manner in which the radiation is spatially, spectrally or temporally excited makes it possible to establish different properties. Contactless measurements additionally promote rapid and damage-free measurement for a large proportion of the solar cells produced. This affords an advantage in particular for thin, large and/or busbar-less solar cells. This can result in increased throughput.

In an advantageous development, there is provision for the primary measurement method to comprise an imaging measurement method and/or a non-imaging measurement method. An imaging measurement method can be, in particular, the aforementioned capture of luminescence images. A non-imaging measurement method is, in particular, measurement of the solar cell by means of contacts, for example the measurement of an IV characteristic curve. A contactless, non-imaging measurement method is, for example, a contactless sheet resistance measurement, the contactless PL-QE measurement, the contactless series resistance measurement, the contactless suns-PL measurement.

As explained above, multiple primary measurements can be carried out on each solar cell by means of different primary measurement methods. By way of example, a first primary measurement method can be a PL method and a second primary measurement method can be an EL method, which are used successively on the same solar cell.

In a preferred embodiment, there is provision for the subset to comprise less than 10% or 1% of the number of the multiple solar cells. This means that, calculated over a period of time, for example over a day or over one or more hours, less than 10% or 1% of the solar cells measured using the primary measurement method are also measured using the secondary measurement method. The fewer solar cells are measured using the secondary measurement method, the greater the throughput. On the other hand, both measurement methods must be carried out regularly on the same solar cell so that the secondary measurement result can be used to calibrate the primary measurement method and/or the primary measurement result. The above percentages refer in particular to averaging over a period of one or more hours. Preferably, at least 5, 9, 50 or 80 solar cells are initially measured exclusively by means of the primary measurement method before a solar cell is measured by means of both measurement methods.

The subset reaches the value of less than 10% or 1% preferably during normal operation after a start-up phase. In other words, at first a basic calibration or basic modeling is carried out during operation for the first time, after a product change, after a process change, after a material change and/or after a longer break, in particular a break for testing or a break in production. This basic calibration involves a large proportion of solar cells produced first being measured both using the primary measurement method and using the secondary measurement method until the sorting precision, i.e. the variability, of the primary measurement method meets the specification. The subset is thus very large here and is preferably close to or at 100%.

Preferably, there is provision for a basic calibration that is preferably effected during start-up or new commissioning of the solar cell production process and/or is repeated at regular intervals, for example weekly. A basic calibration or basic modeling such as this is preferably effected on the basis of sufficiently extensive and representative primary measurements and secondary measurements in order to obtain training data sets and calibration data sets for the calibration therefrom. For this purpose, a high proportion of the solar cells produced is initially preferably subjected to both the primary measurement and the secondary measurement, such that the subset is very high, preferably more than 90% or almost 100%.

A regular basic calibration is preferably not necessary if the production processes and also the substrate material fluctuate only within low specification limits. This means that continuous production without basic calibration can also operate, which involves a small percentage of solar cells constantly undergoing the secondary measurement. This is because each individual secondary measurement already involves the primary measurement result and thus the primary measurement method being checked. A basic calibration is necessary in particular if too great a proportion of the primary measurement results suddenly no longer matches the secondary measurement results, for example because silicon material of a completely different grade than previously is suddenly employed during production.

After such a start-up phase, the solar cell production process preferably changes over to continuous operation, during which recalibration is effected regularly or sporadically on the basis of the measurement results of the secondary measurement. This prevents the primary measurement from drifting in accuracy, i.e. the mean measured value for a subset of at least 10 samples, compared to the secondary measurement. During recalibration, changes are made in model parameters that are used for interpretating the primary measurement results and later classifying and sorting the measured solar cells. It is ensured that primary and secondary measurements remain within the target specification range in terms of both precision and accuracy and thus produce measurement results that are comparable in a defined manner in the long term.

According to a preferred development, there is provision for the calibration of the primary measurement method and/or the primary measurement result to comprise applying machine learning algorithms. This involves multiple pairs of, in each case, a primary measurement result and a secondary measurement result, which were previously determined on a solar cell, being made available to the algorithm. One or more such result pairs used to train the algorithm are determined for each solar cell, with model parameters of the algorithm being determined. Alternatively, in the case of a solar cell for which a result pair comprising a primary measurement result and a secondary measurement result is available, the secondary measurement result can be used to determine a characterization of the solar cell, for example a power value and/or an efficiency. The primary measurement result and the determined characterization can then be used to train the algorithm and determine the model parameters.

Subsequently, the algorithm, with the determined model parameters, is able to respond to a primary measurement result by determining as input an approximation result for the characterization of the solar cell, for example a power value approximation and/or an efficiency approximation. The better the algorithm works, the smaller the gap between the approximation result and the characterization of the solar cell that would have been obtained if the solar cell had been measured by means of the secondary measurement method and the characterization of the solar cell had been derived from the thus determined secondary measurement result. As explained above, a recalibration is preferably carried out at regular intervals, for example at regular intervals of time or after a specific number of solar cells has been tested or following reduced assessment precision of the primary measurement, by subjecting at least one solar cell to both the primary measurement and the secondary measurement. The (post-)calibration is used to minimize the gap between the approximation result for the characterization of the solar cell that is derived from the primary measurement result by means of the algorithm and the characterization of the solar cell that is derived from the secondary measurement result.

If the primary measurement method comprises one or more optical measurement methods (for example photoluminescence measurement methods and/or electroluminescence measurement methods), the calibration is preferably used to adjust or change calibration factors in order to track changes in the transfer of electrical properties to the optical recording technique, e.g. as a result of changes in the optical construction.

There is preferably provision for the calibration of the primary measurement method and/or the primary measurement result to comprise using an artificial neural network. Thus, the algorithm explained above preferably comprises the artificial neural network, and the model parameters are the parameters of the artificial neural network, in particular the weights of the artificial neural network.

The artificial neural network preferably comprises a recurrent neural network (RNN) and/or a convolutional neural network (CNN), in which the activities of the neurons are calculated by means of discrete convolutions. The artificial neural network can comprise multiple layers, one, two or more layers of which are convoluted in this way. If this is an RNN, it is a convolutional recurrent neural network.

### Methodology

I. Calibration of the optical constant (Ai) of optical measurements (EL, PL, or the like). Quantification of the measured value, for example by means of STC measurements or by means of other reference measurements.
II. Rating of high-dimensional (e.g. images), qualitative and quantitative measurement data by way of a statistical model (e.g. machine model, ML) calibrated using correlated STC measurements.
   1. Imaging luminescence images:
      i. Rating of image features, i.e. trained defect objects, and correlation with STC IV parameters.
      ii. STC IV parameters are predicted using statistical methods, e.g. machine learning (ML), on the basis of luminescence images. In particular, deep learning and convolutional neural network (CNN) methods can be used here.
      iii. Additionally, anomaly detection networks (CNN or others) are optionally used to selectively trigger STC measurements. The anomaly detection detects outliers that may be able to be measured precisely only using STC.
   2. Non-imaging measurement sequence consisting of PL, PL-QE, contactless Rs (according to Kasemann et al.), suns-PL

According to another aspect of the invention, a solar cell test installation is proposed. All configurations described above or below in connection with the solar cell test procedure can be implemented accordingly in the solar cell test installation. In addition, all embodiments described above or below in connection with the solar cell production process that concern the solar cell test procedure can be applied accordingly to the solar cell test procedure.

According to another aspect of the invention, a solar cell production plant is proposed. All configurations described above or below in connection with the solar cell production process can be implemented accordingly in the solar cell production plant. In addition, all embodiments described above or below in connection with the solar cell production plant that concern the solar cell test installation can be applied accordingly to the solar cell test installation.

In particular, the solar cell production plant has a production section, a primary measuring apparatus, a secondary measuring apparatus and a sorting apparatus. The production section is designed to produce multiple solar cells. The primary measuring apparatus is designed to carry out at least one primary measurement on substantially each of the multiple produced solar cells by means of a primary measurement method and to determine a primary measurement result for each of the multiple solar cells. The secondary measuring apparatus is designed to carry out at least one secondary measurement on at least one of the produced solar cells by means of a secondary measurement method and thus to determine a secondary measurement result. The sorting apparatus is designed to assign each of the multiple solar cells to a sorting category according to the primary measurement result and/or secondary measurement result associated with the solar cell. According to the invention, the solar cell production plant is designed to carry out the secondary measurement by means of the secondary measurement method on a subset of the multiple solar cells and to calibrate the primary measurement method and/or the primary measurement result according to the secondary measurement result.

A distribution system, for example comprising robot arms and/or conveyor belts, can ensure that all solar cells arrive at the primary measuring apparatus and the subset of solar cells arrives at the secondary measuring apparatus. Alternatively or cumulatively, the installation may be designed in such a way that, although all solar cells produced pass through the primary measuring apparatus and the secondary measuring apparatus, the secondary measuring apparatus is controlled in such a way that only the subset of solar cells that passes through it is also measured by means of the secondary measurement method.

The invention is explained below on the basis of exemplary embodiments with reference to the figures, in which:

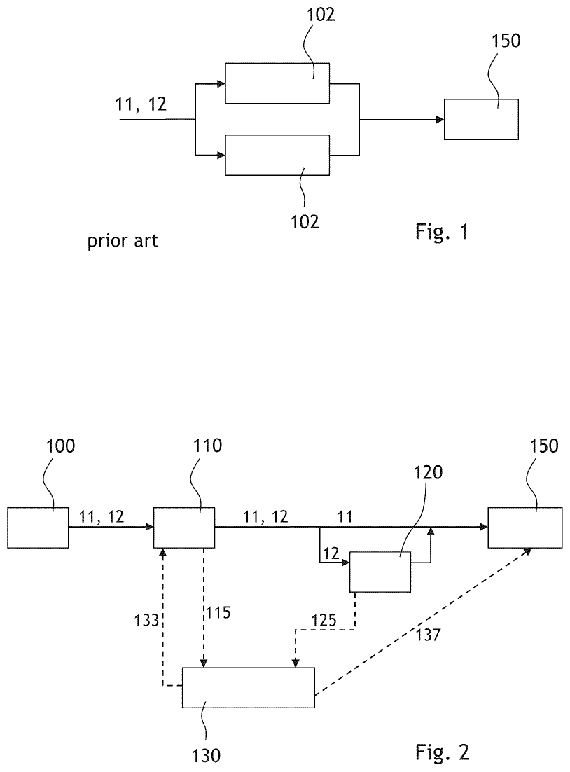

FIG. 1 shows a diagram for a sequence of a test and sorting method according to the prior art;

FIG. 2 shows a solar cell production plant according to a preferred embodiment;

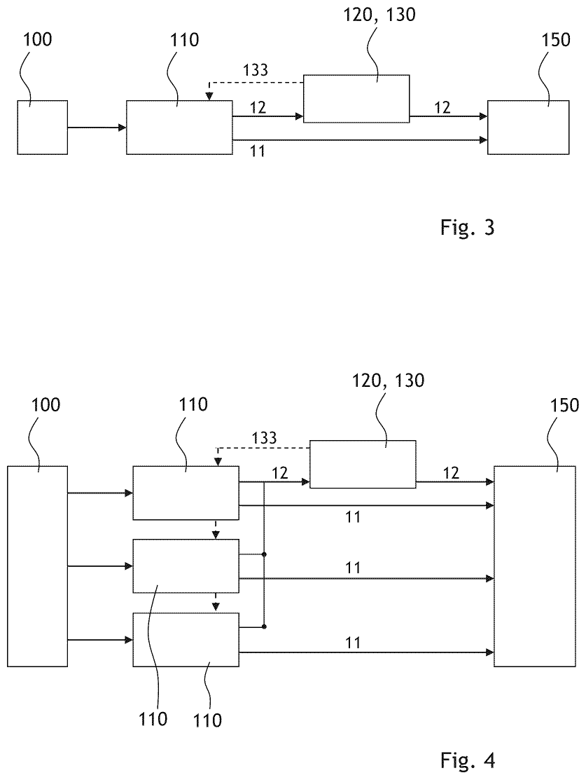

FIG. 3 shows a flow diagram for a solar cell production process according to a preferred embodiment;

FIG. 4 shows a flow diagram for a solar cell production process according to a further preferred embodiment with multiple primary measurements carried out at the same time; and

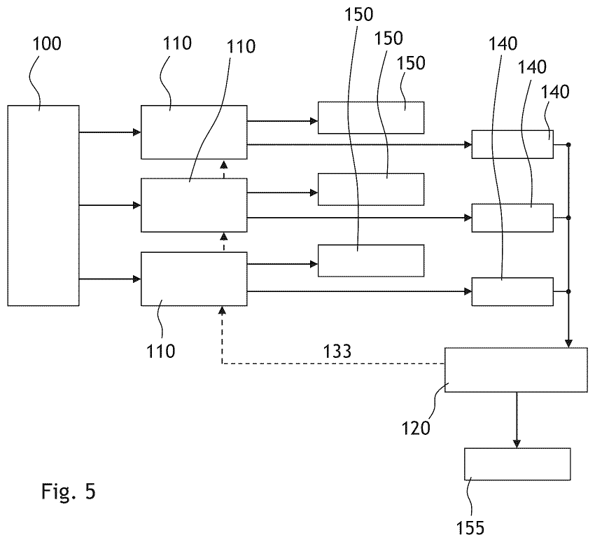

FIG. 5 shows a flow diagram for a solar cell production process according to a further preferred embodiment.

A test and sorting method according to the prior art is illustrated on the basis of a flow diagram shown in FIG. 1. Previously produced solar cells 11, 12 are fed to standard measuring apparatuses 102. The standard measuring apparatus 102 is a tester for measuring solar cells under standard conditions (STC-Standard Test Conditions). These are referred to as STC testers for short. The standard conditions (according to IEC 60904) include in particular standardized illumination/irradiation of the solar cell with a standard light spectrum (AM1.5G). Moreover, each solar cell is electrically contact-connected and its current-voltage measurement curve (IV curve) is measured during the irradiation.

As shown in FIG. 1, two or more standard measuring apparatuses 102 are operated in parallel in order to increase the throughput. As a rule, the standard measuring apparatuses 102 are arranged directly at the end of a production line, thus being employed as so-called end-of-line testing. Each of the produced solar cells 11, 12 is subjected to the standard measurement 102. If, for example, the production line produces 8000 solar cells per hour, 4000 solar cells per hour are measured in each of the two standard measuring apparatuses 102.

It should be pointed out here that the rectangles shown in the diagrams in the figures can represent both method steps in a method and corresponding device modules in a device. FIG. 1 can thus show, as explained above, two standard measuring apparatuses 102, each of which is fed a portion of the produced solar cells 11, 12, or standard measurements 102, which are carried out in parallel on two of the produced solar cells 11, 12 at a time. This dichotomy is used below without needing to be expressly pointed out.

After the standard measurements 102 carried out, the measured solar cells 11, 12 are fed to a sorting 150, the so-called binning. This involves the solar cells 11, 12 being sorted according to the measurement results determined in the standard measurements 102, in particular on the basis of their cell power or cell effectiveness that has been measured, or derived by means of the measurement results.

A solar cell production plant according to a preferred embodiment is shown in FIG. 2. The entire production 100 of the solar cells 11, 12 is summarized in one diagram element in FIG. 2. However, the practical implementation naturally requires many production steps in order to produce a solar cell. It should also be pointed out at this juncture that a produced solar cell according to any configuration described here may merely be a non-contact-connected solar cell. The solar cell produced thus does not necessarily have to be contact-connected. Alternatively, the solar cell may already be fully contact-connected, that is to say electrically connected to the contacts of measuring electronics, before it is subjected to testing.

As shown in FIG. 2, all solar cells 11, 12 are initially subjected to a primary measurement 110 in a primary measuring apparatus 110. For each of the solar cells 11 measured here, the primary measurement 110 is taken as a basis for determining a primary measurement result 115 that is fed to an evaluation module 130 (or to an evaluation). A first subset 11 of the solar cells is fed directly to a sorting 150 after the primary measurement 110. The primary measurement result 115 is used for the sorting 150. This sorting control 137 is indicated in FIG. 2 by a dashed arrow between the evaluation module 130 and the sorting container 150. The evaluation module 130 and the sorting container 150 are supposed to identify modules that have electronic and mechanical elements in order to be able to carry out the corresponding method steps for evaluation or sorting.

A second subset 12 of the solar cells is additionally subjected to a secondary measurement 120 in a secondary measuring apparatus 120, which involves secondary measurement results 125 being generated. These secondary measurement results 125 are also made available to the evaluation module 130. The subsequent sorting 150 of the solar cells of the second subset 12 is effected on the basis of the primary measurement results 115 and/or the secondary measurement results 125, also under the control 137 of the evaluation module 130.

The secondary measurement 120 in the configurations discussed here is a standard measurement 102 according to the prior art. However, it can also be effected by means of another reliable secondary measurement method. By comparison, the primary measurement 110 is effected by means of a primary measurement method, which is faster and/or less expensive than the secondary measurement method. In order to also permit a precise power rating of the measured solar cells 11, 12 on the basis of the primary measurement 110, some of the solar cells, namely the solar cells of the second subset 12, are subjected to the secondary measurement 120. This can be done, for example, by subjecting every x-th solar cell to the secondary measurement 120, or by subjecting one or more solar cells to the secondary measurement 120 after a specific period of time. The secondary measurement results 125 are then used to regularly calibrate the primary measurement method and/or the primary measurement result 115, as is indicated by means of a dashed arrow 133 in FIG. 2.

A flow diagram for a solar cell production process according to a preferred embodiment is shown in FIG. 3. Here, solar cells are initially produced 100, which are then all subjected to a primary measurement 110. A first subset 11 of the solar cells is fed directly to a sorting 150, while a secondary measurement 120 is carried out on a second subset 12. The secondary measurement 120 involves an evaluation 130 of the primary measurement results and the secondary measurement results for the solar cells from the second subset 12 also being effected. In response to the result of this evaluation, a calibration 133 of the primary measurement method is effected. Under certain circumstances, the calibration can be dispensed with, for example a calibration is not required if the primary measurement has already produced exactly the right result or if there is provision for the primary measurement not to be recalibrated immediately for the first secondary measurement that does not correlate with the primary measurement.

The solar cell production process shown in FIG. 4 differs from that shown in FIG. 3 in that, here, three primary measurements 110 are effected at the same time to increase the throughput of solar cells. Here too, the primary measurement 110 is effected on all solar cells 11, 12, while the secondary measurement 120 is carried out only on a subset 12 of the solar cells. However, the produced solar cells 11, 12 are split into three groups that are subjected to the primary measurements 110 at the same time. While the process shown in FIG. 3 is particularly advantageous when the primary measurement 110 is effected much faster than the secondary measurement 120, the process according to FIG. 4 is advantageous in particular when the primary measurement 110 or the primary measuring apparatus 110 is particularly inexpensive compared to the secondary measurement 120. In the latter case, multiple primary measuring apparatuses 110 can then be installed inexpensively, which cause a further increase in throughput.

FIG. 5 shows a flow diagram for a solar cell production process according to a further preferred embodiment. The advantage of this embodiment is a possibly easier association of the solar cells with their production lines and the specific calibration of the primary measurement of each production line compared to a global calibration across all primary measurement stations.

As explained above, the elements in the diagrams of FIG. 2-5 can represent devices or method steps according to their function. If they represent method steps, the solar cell currents shown by the arrows can be interpreted in such a way that the associated solar cells undergo or do not undergo the method steps shown. In other words, the solar cells can also pass through a device without undergoing the method step performed with this device. Specifically, this means in particular that, according to one configuration, although all solar cells produced pass through both the primary measuring apparatus and the secondary measuring apparatus, the secondary measuring apparatus then only carries out the secondary measurement on said subset of solar cells.

The calibration of the primary measurement by means of the secondary measurement according to a preferred embodiment is explained below. This calibration method is based on a method known from the publication Y. Buratti et al., “End-of-Line Binning of Full and Half-Cut Cells using Deep Learning on Electroluminescence Images”, in 2020 47th IEEE Photovoltaic Specialists Conference (PVSC), June 2020, No. 1, pages 133-138, and can be divided into four steps, the subsequent references to method steps “Step 1”, “Step 2” and “Step 3” referring to FIG. 1 in this publication:
a) First, an optical constant is determined as the result of the primary measurement by virtue of a correlation of the open terminal voltage and the signal strength of the primary measurement by way of the secondary measurement (e.g. for a PL measurement by means of the formula Voc=kT/q*In(C*I_{PL}), where C is the optical calibration constant.
b) A CNN is then trained. This can be done automatically or by a human being (e.g. a quality engineer). To train the CNN, defect structures in primary measurement results (e.g. in PL and/or EL images) are detected, marked and typed. As a result, the CNN learns to automatically detect and type similar defect structures on unknown images.

At the same time, the CNN also learns to define a defect-free primary measurement result. In addition, it can use the existing quantitative signal calibration (factor C, see step a)) to determine whether the absolute signal of the defect-free solar cell has changed (Step 1)
c) Next, a correlation of the primary measurement result (vector of information signal strength, defect list) from solar cells and the secondary measurement (e.g. STC power measurement) is effected in addition. This data correlation is used to carry out a high-dimensional regression (machine model) that assigns a power value to detected defects and signal strengths as clearly as possible (Step 2).
d) Steps a) to c) are carried out until the primary measurement can predict the secondary measurement to a defined precision and accuracy with respect to the sorting parameters (Isc, Voc, FF, effectiveness). This completes the calibration of the primary measurement.

A fractional recalibration process according to an advantageous configuration is described below. This is a recalibration that is carried out regularly or sporadically during normal operation. It can have the following steps:
a. A certain percentage of the solar cells is always, that is to say regardless of the primary measurement results, directed to the secondary measurement. This ensures a fractional prompt check on the prediction.
b. If the check detects an increased variance, i.e. poor precision, or a drift, i.e. an excessive deviation in the mean measured value, e.g. in Isc, Voc, FF or effectiveness, caused e.g. by a change in the optical constant in the primary measurement, the prediction model is relearnt/recalibrated. In the event of very large deviations, a recalibration is possible (e.g. for new raw wafer material, different coating, different texture, etc.).

A selective recalibration process according to an advantageous configuration is described below. This is a recalibration that is carried out during normal operation if the primary measurement results justify this. It can have the following step:
a. If the CNN of the primary measurement does not achieve sufficient precision in the detection of defects, or in the prediction of the machine model, or anomalies are detected, the secondary measurement is automatically activated and the CNN or the ML model is relearnt (automatically or with the assistance of a quality assurance engineer if marking is required). However, the precision of the CNN is defined here not as a spread of power parameters but as a value between 0 and 1, the frequency of the correct prediction of a defect and its type in relation to the number of defects of this type being available.

### LIST OF REFERENCE SIGNS

11 first subset of solar cells
12 second subset of solar cells
100 step of producing solar cells, production section of the production apparatus
102 standard measurement, standard measuring apparatus
110 primary measurement, primary measuring apparatus
115 primary measurement result
120 secondary measurement, secondary measuring apparatus
125 secondary measurement result
130 evaluation module
133 calibration
137 sorting control
140 solar cell selection
150 sorting, sorting container

1. A solar cell test procedure for testing multiple produced solar cells, comprising the following steps:
carrying out at least one primary measurement on substantially each of the multiple solar cells by means of a primary measurement method to determine a primary measurement result, for each of the multiple solar cells
carrying out a secondary measurement on at least one of the produced solar cells by means of a secondary measurement method to determine a secondary measurement result; and
assigning each of the multiple solar cells to a sorting category according to the primary measurement result and/or secondary measurement result associated with the solar cell.
wherein the secondary measurement by means of the secondary measurement method is carried out on a subset of the multiple solar cells and in that the primary measurement method and/or the primary measurement result are/is calibrated according to the secondary measurement result.

2. The solar cell test procedure as claimed in claim 1, wherein the primary measurement method comprises a contactless measurement method.

3. The solar cell test procedure as claimed in claim 1, wherein the primary measurement method comprises an imaging measurement method and/or a non-imaging measurement method.

4. The solar cell test procedure as claimed in claim 1, wherein the secondary measurement method comprises a contact-connecting measurement method.

5. The solar cell test procedure as claimed in claim 1, wherein the calibration of the primary measurement method and/or the primary measurement result comprises applying artificial intelligence algorithms, in particular machine learning algorithms.

6. The solar cell test procedure as claimed in claim 5, wherein the calibration of the primary measurement method and/or the primary measurement result comprises using an artificial neural network.

7. The solar cell test procedure as claimed in claim 1, wherein the subset comprises less than 10%, 1% or 0.1% of a number of the multiple solar cells.

8. A solar cell production process comprising producing multiple solar cells and testing the produced multiple solar cells using a solar cell test procedure as claimed in claim 1.

9. A solar cell test installation having:
a primary measuring apparatus for carrying out at least one primary measurement on substantially each of multiple solar cells by means of a primary measurement method to determine a primary measurement result for each of the multiple solar cells;
a secondary measuring apparatus for carrying out a secondary measurement on at least one of the produced solar cells by means of a secondary measurement method to determine a secondary measurement result; and
a sorting apparatus for assigning each of the multiple solar cells to a sorting category according to the primary measurement result and/or secondary measurement result associated with the solar cell, wherein the solar cell production plant is designed to carry out the secondary measurement by means of the secondary measurement method on a subset of the multiple solar cells and to calibrate the primary measurement method and/or the primary measurement result according to the secondary measurement result.

10. A solar cell production plant having a production section designed to produce multiple solar cells and having a solar cell test installation as claimed in claim 9.
